(19) United States
(12) Patent Application Publication
(10) Pub. No.: US 2021/0255898 A1
(43) Pub. Date: Aug. 19, 2021

(54) SYSTEM AND METHOD OF PREDICTING APPLICATION PERFORMANCE FOR ENHANCED USER EXPERIENCE

(71) Applicant: SURESH BABU REVOLED KONTI, LEWIS CENTER, OH (US)

(72) Inventor: SURESH BABU REVOLED KONTI, LEWIS CENTER, OH (US)

(21) Appl. No.: 17/306,694

(22) Filed: May 3, 2021

Related U.S. Application Data
(60) Provisional application No. 63/022,959, filed on May 11, 2020.

(51) Int. Cl. G06F 9/50; G06N 20/00; G06N 5/04; G06F 11/30; G06F 11/34

(52) U.S. Cl. CPC G06F 9/50; G06N 20/00; G06N 5/04; G06F 2209/5021; G06F 11/3438; G06F 11/3495; G06F 11/302

(57) ABSTRACT

A system and method for optimizing the allocation of available system resources for smooth running of the system and enhanced user metrics. The system can monitor the applications including user interactions with the applications for determining the criticality of an application. The system can provide for historical and real-time analysis of the applications and classification of the applications as critical or non-critical. Based on the classification, the system can predictively provide for autonomous optimization and distribution of the system's resources between the critical and non-critical applications.

### CROSS-REFERENCE TO RELATED APPLICATIONS

This application claims priority to the U.S. provisional patent application Ser. No. 63/022,959, filed on May 11, 2020, which is incorporated herein by reference in its entirety.

### FIELD OF THE INVENTION

The present invention generally relates to a system and method for prioritization of resources for selected applications, and more particularly, the present invention relates to a system and method for autonomous analyzing the criticality of applications and prioritizing the resources based on the criticality for smoother system performance and enhanced user metrics.

### BACKGROUND

Resources of a system are generally limited and depend upon the budget and availability. For better performance, an application running on a system requires more resources. The allocation/distribution of resources in a system is generally crudely managed and the majority chunk of the system's resources can be drawn by undesired applications. For cost efficiency, the operators generally attempt to utilize the resources to full. However, lack of efficient resource management leads to poor overall user experience. Frequent breakdowns, users not able to access the critical applications or website are some of the common issues faces faced by the users. A user may also face a lack of responsiveness, data loss, interrupted connections, or other malfunctions. It does not matter if how good the supported technology or applications are, the end-user is not able to use it to their satisfaction due to a shortage of system resources.

Manual allocation of resources can be challenging if not possible. Moreover, considering the huge range of applications and changing user requirements, a desire is there for an autonomous system and method for monitoring the applications and predicting prioritization of the resources.

### SUMMARY OF THE INVENTION

The following presents a simplified summary of one or more embodiments of the present invention in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments in a simplified form as a prelude to the more detailed description that is presented later.

The principal object of the present invention is therefore directed to predictive analytical processes and supporting algorithms as applied in a single coherent system to prioritize critical applications during projected moments of resource scarcity.

It is another object of the present invention to provide an enhanced end-user experience and user metrics.

It is still another object of the present invention that the system and method prevent failures or breakdowns.

It is yet another object of the present invention that the system and method keep the core functions running in the event of a resource shortage.

In one aspect, disclosed is a system and method for optimizing the allocation of available system resources including base processing power, digital memory, input/output bandwidth, network bandwidth, and like limited resources known to a skilled person that affects the performance of a computing environment. The disclosed system can monitor the applications including user interactions with the applications for determining the criticality of an application. The disclosed system and method provide for historical and real-time analysis of the applications and classification of the applications as critical or non-critical. Based on the classification, the disclosed system can predictively provide for autonomous optimization and distribution of the system's resources.

These and other objects and advantages of the embodiments herein and the summary will become readily apparent from the following detailed description taken in conjunction with the accompanying drawings.

### BRIEF DESCRIPTION OF THE DRAWINGS

The accompanying figures, which are incorporated herein, form part of the specification and illustrate embodiments of the present invention. Together with the description, the figures further explain the principles of the present invention and to enable a person skilled in the relevant arts to make and use the invention.

FIG. 1 is a block diagram showing the disclosed system, according to an exemplary embodiment of the present invention.

FIG. 2 is a flowchart showing the steps of the disclosed method, according to an exemplary embodiment of the present invention.

### DETAILED DESCRIPTION

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely for the purpose of illustrating the general principles of the invention, since the scope of the invention will be best defined by the allowed claims of any resulting patent.

Disclosed is a system and method for analyzing applications running on a system to determine the criticality of the applications. The disclosed system can analyze the historical usage data and real-time monitoring of the applications. The present invention describes a novel combination of predictive analytical processes and supporting algorithms as applied in a single coherent system to prioritize critical applications during projected moments of resource scarcity.

The disclosed system and method provides for optimizing the allocation of available system resources such as base processing power, digital memory, input/output bandwidth, and network bandwidth. It is to be understood that any other system resource known to a skilled person of a limited capacity that can affect the performance of the system or user experience is within the scope of the present invention. The disclosed system can keep the core functions running even in the event of a resource shortage, or ‘crunch’, preventing breakdowns and failures.

The disclosed system and method can support most of the known operating platforms in various deployed iterations, including support for the mobile operating systems including Android and iOS; Unix-based operating systems such as Linux and AIX, and the Windows operating system in its various forms.

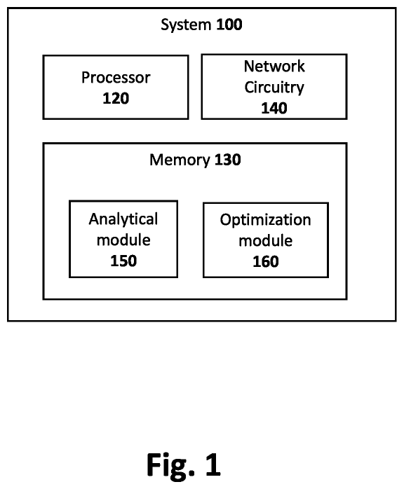

Referring to FIG. 1, which is a block diagram showing the disclosed system 100. The system 100 can include a processor 120, memory, 130, and a network circuitry 140. The memory 130 and the network circuitry 140 operably coupled to the processor 120. The memory can include an analytical module 150 and an optimization module 160. The analytical module 150 when executed by the processor provides for analysis of the historical and real-time application usage and user interactions with the applications. Based on the analysis the disclosed analytical module can classify the applications into critical and non-critical applications. The critical application can be those applications that are essential for the smooth running of the disclosed system. The critical files may also include those applications that may be essential for enhanced user experience or user metrics. For example, the application providing critical services to the user can be classified as a critical application. It is to be understood that critical and non-critical cannot absolute but can include sub-levels, such as core critical applications and user critical applications. The sublevels themselves may have a different level of criticality.

The disclosed analytical module 150 may also include a pre-trained machine learning module that can be trained using large application usage history datasets across different platforms. The pre-trained machine learning module can identify the core application that may be essential for the smooth running of the system. The pre-trained machine learning module may also identify non-critical applications that may be closed without affecting the system performance or critical services to the users. The training of the machine learning model may require a volume of historical data or training data pertaining to user activity and more specifically relating to the frequency of use and historical resource demands related to any given application. Accurate projections may be achieved by a singular use or composite use of various algorithmic approaches. Different algorithmic approaches can be used including Autoregression (AR), Moving Average (MA), Autoregressive Moving Average (ARMA), Autoregressive Integrated Moving Average (ARIMA), Seasonal Autoregressive Integrated Moving-Average (SARIMA), Seasonal Autoregressive Integrated Moving-Average with Exogenous Regressors (SARIMAX), Vector Autoregression (VAR), Vector Autoregression Moving-Average (VARMA), Vector Autoregression Moving-Average with Exogenous Regressors (VARMAX), Simple Exponential Smoothing (SES), Holt Winter's Exponential Smoothing (HWES), and other means of time-scaled data analysis known to a skilled person.

The analytical module 150 can present the list of applications under different classifications to a user for review. The user may manually modify the classification of any application. For example, a user may change the critical application to non-critical and vice-versa. The analytical module 150 may also request a user to classify a particular application. For example, those applications which the analytical module 150 cannot recognize can be presented to a user for classification. Alternatively, the analytical module 150 can classify the application and get it approved by the user. In another case, the analytical module 150 can classify the application and notify the user about the classification.

Classification of applications by the analytical module 150 may not be a one-time activity, but a continuous process. The disclosed analytical module 150 can run a background process and monitor the applications and services. It is to be noted that the term applications include services. The analytical module 150 can monitor various observable metrics such as time-in-use, resource demands, network activity, or other factors that may positively indicate that an arbitrary critical application is to be allocated resources over an arbitrary non-critical. The analytical module 150 can identify new applications and review the known applications.

The optimization module 160 can provide for autonomous and predicted allocation of the system's resources between the critical application and the non-critical applications. The optimization module 160 may not generally suppress the running of applications, but predictively provide a preference of resources to the critical applications. The resources of the system can be utilized at their fullest capacity, but the critical applications can be intelligently prioritized over the non-critical applications by the optimization module 160. Moreover, the optimization module 160 can predict trends of resource usage by the non-critical applications over time that may compromise the functionality of the critical applications. Such non-critical applications may be suppressed timely to prevent any breakdown or halt. The disclosed system can predict the requirement of resources for the critical applications for smooth functioning of the system and enhanced user experiences or user metrics. By predicting the projected requirement of the resources for a critical application, the optimization module 160 can ensure that critical applications may not be affected by the shortage of resources or real-time suppression of other applications may not be required to free up the resources. The optimization module 160 can identify trends in resource usage by critical applications and such resources can be kept free intelligently without sacrificing the overall cost efficiency of the system.

Ensuring the availably of resources to the critical applications, the user experience can be improved, and critical services can be provided to the users without failure or lags. Moreover, failures or breakdown of the system can be prevented allowing smooth running of the system.

In one exemplary embodiment, the disclosed system can be implemented using ‘Python’ programming framework utilizing the ‘pandas’ library in a preferred embodiment, wherein long short-term memory neural networks may be applied to predict the resource requirements and projected overages of a system and sequentially pare down a list of active applications until the projecting resource usage peak falls below a maximum resource allocation limit.

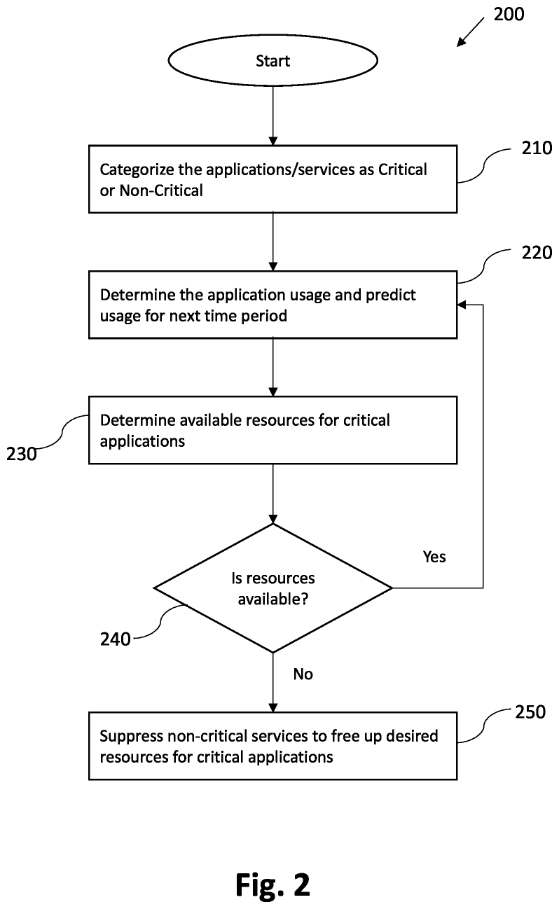

Referring to FIG. 2, which is a flow chart showing an exemplary embodiment of the disclosed method 200 of optimization and allocation of system resources. First, the method includes the step of categorizing/classifying applications, including the services or processes, into two broad categories, i.e., critical, and non-critical applications. After classifying the applications at step 210, the system can determine the application usage and predict the usage of the application for a subsequent period, at step 220. The period can be any suitable period, such as 4 hours. The period can be modified and may vary for different applications. Thereafter, the disclosed system can predict if sufficient resources are available for critical applications, at step 230. A check for the available and predicted resources can be made at step 240. If sufficient resources are available, at step 240, the system can keep monitoring the application and resources. If sufficient resources are not available or will not be available for the critical applications, at step 240, the disclosed system can suppress the non-critical process, till sufficient resources can be made available, at step 250.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A method for enhancing the performance of a computing system having a processor and memory, the method comprising the steps of:
monitoring and analyzing, by an analytical module, applications usage and user interaction with the applications;
upon analysis, classifying the applications as critical applications or non-critical applications;
upon classification, determining by the optimization module, current usage of the applications, and predicting the usage of the application in a predefined period;
determining, by the optimization module, requirement of resources for one or more critical applications; and
upon determining the requirement, freeing up the required resources for the one or more critical applications by suppressing one or more of the non-critical applications.

2. The method according to claim 1, wherein the step of determining the requirement of the resources further comprises predicting, by the optimization module, a projected requirement of resources for the one or more critical applications.

3. The method according to claim 2, wherein the resources comprise base processing power, digital memory, input/output bandwidth, and network bandwidth.

4. The method according to claim 1, wherein the computing system is a mobile computing system based on Android or iOS.

5. The method according to claim 1, wherein the critical applications directly affects the computing system performance and non-critical applications can be closed without significantly affecting the performance of the computing system.

6. The method according to claim 1, wherein the analytical module comprises a pre-trained machine learning model that can identify critical and non-critical applications, the pre-trained machine learning model is trained using historical applications usage data, the historical applications usage data includes frequency of usage of applications and resources used by the applications.

7. The method according to claim 1, wherein the monitoring and analyzing step further comprises analyzing historical applications usage data and near real time application usage for metrics including time-in-use, resource demands, and network activity.

8. The method according to claim 2, wherein the method further comprises the steps of:
determining, by the optimization module, a trend of resources usage by the one or more non-critical applications, wherein the trend indicates the possibility of affecting the performance of the one or more critical applications by the one or more non-critical applications; and
upon determining the one or more non-critical applications that is known to affect the performance of the one or more critical applications, suppressing the one or more non-critical applications.

9. A computing system with enhanced performance, the computing system having a processor and memory, the memory operably coupled to the processor, wherein the memory includes an analytical module and an optimization module,
wherein the analytical module upon execution by the processor causes:
monitor and analyze applications usage and user interaction with the applications;
upon analysis, classify the applications as critical applications or non-critical applications;
wherein the optimization module upon execution by the processor causes:
upon classification, determine current usage of the applications and predicting the usage of the application in predefined period;
determine a requirement of resources for one or more critical applications; and
upon determining the requirement, free up the required resources for the one or more critical applications by suppressing one or more of the non-critical applications.

10. The computing system according to claim 9, wherein the optimization module further causes:
predict a projected requirement of resources for the one or more critical applications, wherein free up the required resources further depends on the projected requirement of resources for the one or more critical applications.

11. The computing system according to claim 10, wherein the resources comprise base processing power, digital memory, input/output bandwidth, and network bandwidth.

12. The computing system according to claim 9, wherein the computing system is a mobile computing system based on Android or iOS.

13. The computing system according to claim 9, wherein the critical applications directly effects the computing system's performance and non-critical applications can be closed without significantly affecting the performance of the computing system.

14. The computing system according to claim 9, wherein the analytical module comprises a pre-trained machine learning model that can identify critical and non-critical applications, the pre-trained machine learning model is trained using historical applications usage data, the historical applications usage data includes frequency of usage of applications and resources used by the applications.

15. The computing system according to claim 9, wherein the monitor and analyze applications comprises analyzing historical applications usage data and near real time applications usage for metrics including time-in-use, resource demands, and network activity.

16. The computing system according to claim 10, wherein the optimization module further causes:
determine a trend of resources usage by the one or more non-critical applications, wherein the trend indicates the possibility of affecting the performance of the one or more critical applications by the one or more non-critical applications; and
upon determining the one or more non-critical applications that are known to affect the performance of the one or more critical applications, suppress the one or more non-critical applications.
